(19) United States
(12) Patent Application Publication
(10) Pub. No.: US 2026/0300022 A1
(43) Pub. Date: Oct. 1, 2026

(54) Dynamic GPU Availability Tracking

(71) Applicant: CAST AI Group, Inc., Miami, FL (US)

(72) Inventors: Joy Neuberger, New York, NY (US); Leonid Kuperman, North York (CA)

(21) Appl. No.: 19/556,887

(22) Filed: Mar. 4, 2026

Related U.S. Application Data
(60) Provisional application No. 63/781,245, filed on Mar. 31, 2025.

(51) Int. Cl. G06F 9/50; G06T 11/26

(52) U.S. Cl. CPC G06F 9/5044; G06T 11/26; G06T 2200/24

(57) ABSTRACT

A method or a system for visualizing the stability and availability of GPU instances in a cloud computing environment. The system obtains current data related to GPU instances across multiple geographic regions and cloud service providers, and determines GPU availability metrics for each region. A dynamic visualization is generated, where each region is visually indicated based on the corresponding availability metrics. The visualization is updated in real time as metrics change. Additionally, the system outputs a recommended GPU allocation, identifying optimal regions for deployment.

### CROSS REFERENCE TO RELATED APPLICATION

The present application claims the benefit of U.S. Provisional Application No. 63/781,245, filed Mar. 31, 2025, which is incorporated in reference in its entirety.

### BACKGROUND

Graphics Processing Units (GPUs) have become increasingly popular due to their ability to handle highly parallel computations, making them essential for modern artificial intelligence (AI), machine learning (ML), and high-performance computing (HPC) workloads. Unlike traditional Central Processing Units (CPUs), which process tasks sequentially, GPUs excel at performing thousands of simultaneous operations, making them ideal for deep learning model training, scientific simulations, and data-intensive tasks. The rise of AI-driven applications, such as large language models (LLMs), computer vision, and real-time data analytics, has significantly increased the demand for GPUs. Additionally, GPUs offer increased power, which has advanced gaming, video rendering, and cryptocurrency mining, further driving their adoption. With cloud service providers (CSPs) offering GPU instances, entities can now access scalable, high-performance computing resources without investing in expensive hardware, enabling rapid innovation in AI research, autonomous systems, and enterprise applications.

CSPs may offer GPU instances as spot instances or as on-demand instances. Spot instances offer a flexible option for entities to utilize unused computing capacity in cloud computing. This option allows entities to access these resources without the long-term commitments required by standard on-demand instances. Yet, the availability of spot instances is subject to dynamic fluctuations, driven by the changing supply and demand for computing resources. Increased use of on-demand instances leads to a scarcity of spot instances, while lesser use makes more spot instances available. Likewise, a rise in requests for spot instances diminishes their availability. Should the need for additional resources arise, a cloud service provider may, according to its policies, terminate or pause a spot instance to accommodate an on-demand subscriber's requirements.

Recently, GPU instances face significant availability and stability challenges due to limited supply and high demand. Different cloud service providers offer varying GPU instance types across regions, and some regions lack GPU support entirely. Users lack visibility into where GPU instances (including spot and on-demand instances) are most stable and often waste computational efficiency and allocations when attempting to provision resources in regions with little to no availability. This technical problem results in inefficient resource allocation, increased operational costs, and degraded performance for compute-intensive workloads. Existing cloud management tools fail to provide real-time, cross-provider visibility into GPU availability and stability metrics, forcing users to rely on trial-and-error approaches that consume time and resources. The unpredictable nature of spot instance interruptions and insufficient capacity errors further compounds this problem, as users cannot accurately predict when or where GPU resources will become available. Consequently, there exists a need for a technical solution that collects, analyzes, and visualizes GPU availability data across multiple cloud providers and geographic regions, enabling informed resource allocation decisions based on real-time and predictive metrics.

### SUMMARY

GPU instances face significant availability and stability challenges due to limited supply and high demand. Different cloud service providers offer varying GPU instance types across regions, and some regions lack GPU support entirely. Users lack visibility into where GPU instances (including spot and on-demand instances) are most stable and often waste computational efficiency and allocations when attempting to provision resources in regions with little to no availability. The present disclosure relates to systems and methods for visualizing the stability and availability of GPU instances in a cloud computing environment. The method includes obtaining real-time data pertaining to GPU instances across multiple geographic regions and cloud service providers. Based on this data, the system computes availability metrics for each region and generates a dynamic visualization that uses visual indicators to represent varying levels of GPU availability. When changes in availability metrics are detected, the visualization is automatically updated to reflect the current status. The system further generates and displays GPU allocation recommendations, identifying optimal geographic regions and cloud service providers for resource deployment. Both the visualization and the allocation recommendations are presented through a graphical user interface, enabling users to make informed decisions regarding GPU resource management in distributed cloud environments.

This approach provides a technical solution to the problem of inefficient GPU resource allocation in distributed cloud environments by enabling real-time visibility into GPU availability and stability across multiple cloud service providers and geographic regions, thereby reducing wasted computational resources and improving operational efficiency for compute-intensive workloads.

### BRIEF DESCRIPTION OF THE DRAWINGS

FIG. 1 is a block diagram of a system environment in which an online system, such as a cloud region stability prediction system, in accordance with one or more embodiments.

FIG. 2 is a flowchart illustrating an example process of generating a map that visualizes stability or instability within cloud regions, in accordance with one or more embodiments.

FIG. 3 illustrates an example architecture of the cloud region stability prediction system in accordance with one or more embodiments.

FIG. 4 illustrates an example environment in which a Kubernetes agent within a Kubernetes cluster is configured to serialize and send serialized data to a cloud region stability prediction system, in accordance with one or more embodiments.

FIG. 5 illustrates another example environment, in which an agent facilitates data collection within a cluster and transmits the collected data to a cloud region stability prediction system in accordance with one or more embodiments.

FIG. 6A-6E illustrate examples of user interface (UI) generated based on the data collected from spot instances across different regions of a cloud service provider in accordance with one or more embodiments.

FIG. 7 is a flowchart of one embodiment of a method for collecting and processing data related to GPU instances and generating a heatmap based on the processed data in accordance with one or more embodiments.

FIG. 8 is a block diagram of an example computer suitable for use in the networked computing environment of FIG. 1 in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Cloud computing environments rely on various types of compute instances, such as spot instances and GPU instances, for efficient and scalable resource management. GPU instances are in high demand due to their role in AI and machine learning applications, but their availability is limited and varies by region and cloud provider. Users often lack real-time insights into where GPUs are available and how stable spot instances are, leading to wasted time and inefficient resource allocation.

The embodiments described herein include a system and method for tracking and visualizing the availability and stability of GPU instances across different cloud regions and providers. The system collects real-time data on instance failures, interruptions, and availability from multiple cloud providers. The system also analyzes this data to determine stability levels and presents the results through an interactive visualization. The visualization enables users to quickly identify the most stable spot instances and locate regions with the highest GPU availability, reducing trial-and-error attempts in resource provisioning. By providing actionable insights into GPU availability and stability across multiple cloud service providers and geographic regions, the system prevents wasted computational efficiency and allocations that would otherwise result from provisioning attempts in regions with insufficient capacity or high interruption rates.

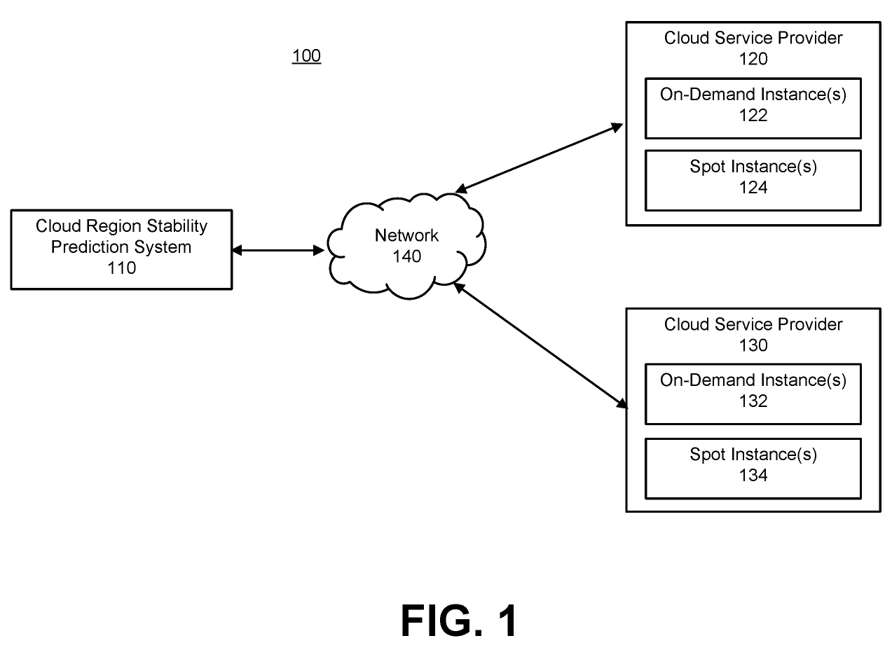

Additional details about the system and method for collecting and analyzing data about GPU instances across different regions and cloud service providers are further described below with respect to FIGS. 1-7.

### System Architecture

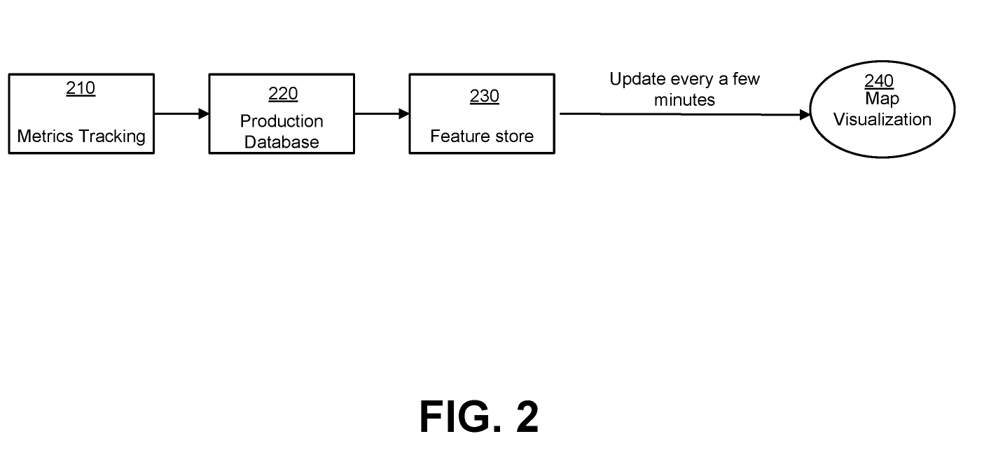

FIG. 1 is a block diagram of a system environment 100 in which an online system, such as a cloud region stability prediction system 110, as further described below in conjunction with FIGS. 2-7, operates. The system environment 100 shown by FIG. 1 comprises a cloud region stability prediction system 110 ("the system"), a plurality of cloud service providers 120, 130, and a network 140.In alternative configurations, different and/or additional components may be included in the system environment 100. The cloud service providers 120 and 130 may include (but are not limited to) Amazon Web Service (AWS), Microsoft Azure, and Google Cloud service provider (GCP). Additional details about cloud service providers and Kubernetes clusters are described in commonly-owned US Patent Application 17/380,729, filed Jul. 20, 2021, now issued as US Patent No. 11,595,306, the disclosure of which is hereby incorporated by reference herein in its entirety.

The cloud service providers 120, 130 offer both on-demand instances 122, 132, and spot instances 124, 134. On-demand instances 122, 132 allow entities to access compute capacity in chunks (e.g., by the hour or second, depending on the cloud service provider). Entities can launch an on-demand instance at any time and use it for as long as they need, making on-demand instances an ideal option for applications with important workloads that cannot be interrupted. Spot instances 124, 134 offer unused computing capacity at significantly lower cost compared to on-demand rates. However, these instances can be reclaimed by the cloud service provider with very short notice (e.g., if there is an increase in demand). Spot instances are suitable for flexible, interruption-tolerant applications, such as batch processing jobs, background tasks, and workloads that can be quickly checkpointed and resumed.

The system 110 is configured to obtain data regarding GPU instances, such as on-demand instances 122, 132 and spot instances 124, 134, on cloud service providers 120, 130 over the network 140. The GPU instances 122, 124, 132, 134 may be hosted at various regions. Each region further includes multiple availability zones (AZs). These AZs are physically separate datacenters within a region that provide high availability, fault tolerance, and redundancy. In the same region, each AZ is isolated from failure in other AZs but is connected to each other with low-latency networking. For example, each AZ has independent power, cooling, and networking to withstand failures in other AZs.

The data regarding GPU instances obtained by system 110 includes data associated with the geographic regions and/or AZs. Once collected, the system analyzes the data to identify any instances 122, 124, 132, 134 that have experienced disruptive failures. These failures, including interruptions or failures in resource provisioning, are used in assessing the availability and/or stability of the instances 122, 124, 132, 134 in different regions of different cloud service providers 120, 130. Following the identification of these failures, the system 110 determines the stability levels of instances 122, 124, 132, 134 across the different regions for each cloud service provider 120, 130. In some embodiments, this determination is based on a frequency and nature of the disruptive failures identified earlier. The system 110 then generates a visualization that represents these stability levels across the various regions and cloud service providers. In some embodiments, the visualization is configured to be interactive, allowing users to engage with the data and uncover metrics related to the availability and stability levels of the instances 122, 124, 132, 134.

In some embodiments, the data is collected through deployment of agents on instances 122, 124, 132, 134. These agents are tasked with monitoring the performance and stability of the instances 122, 124, 132, 134, collecting relevant data, and sending it to the system 110 for further analysis. In some embodiments, processing the collected data includes extracting features related to disruptive failures and filtering these features to identify instances prone to interruptions or provisioning failures. The features include, but are not limited to, timestamps and locations of interruptions, reasons for these interruptions, timestamps and locations where provisioning requests were refused, the types of resources requested, and reasons for these refusals, thereby providing insight into the encountered issues.

In some embodiments, the system uses a machine learning model trained on historical data to predict future capacity and stability for a given region and cloud service provider 120, 130, providing foresight into potential stability and stability issues. In some embodiments, based on the determined stability levels, the system 110 provides recommendations regarding the most reliable regions and cloud service providers 120, 130 for using instances 122, 124, 132, 134. This guidance is invaluable for entities looking to optimize their cloud resource utilization while minimizing the risk of disruptions. By directing users to regions with higher availability and lower interruption rates, the system 110 prevents the waste of computational resources that would otherwise occur when users attempt to provision GPU instances in regions experiencing capacity constraints or frequent spot instance recalls.

FIG. 2 is a flowchart illustrating an example process 200 of generating a map visualization in accordance with one or more embodiments. The process 200 includes collecting and tracking 210 operational metrics as time-series data from different instances (e.g., on demand instances 122, 132, spot instances 124, 134) across different cloud service providers (e.g., cloud service providers 120, 130). In some embodiments, the data collection may be performed via a data collection application configured to employ a pull model to collect and monitor resources and generate alerts in the cloud computing environment. The data collection application may be an open source application, such as (but not limited to) Prometheus, or a proprietary application provided by the system 110.

The operational metrics may include (but are not limited to) spot instance stability, measuring the availability and/or stability of instances over time; cost savings, tracking the cost savings from using spot instances versus on-demand instances; resource utilization, monitoring CPU, memory, disk, and network usage of spot instances; instance interruptions, tracking times when spot instances are interrupted by the cloud service provider; reclamation time, tracking the duration from when a spot instance is reclaimed to when it becomes available again; provisional failures, tracking times when a request to provision resources at a spot instance fails; failure rates, monitoring the rate of failed spot instance requests; and provisioning latency, measuring the time to provision or start a spot instance after a request.

After the data is collected, the data is stored relationally in a database 220. In some embodiments, the database 220 may be an open source database, such as (but not limited to) a product PostgreSQL database. Alternatively, the database 220 may be a proprietary database provided by the system 110. The collected data stored in the database may then be analyzed to generate features, which are, in turn, stored in a feature store 230. In some embodiments, the feature store is a Feast feature store, which is a feature store that aims to simplify the management and use of features for real-time predictions. The features stored in the feature store 230 are periodically updated (e.g., every few minutes) and used to generate an updated instability map 240.

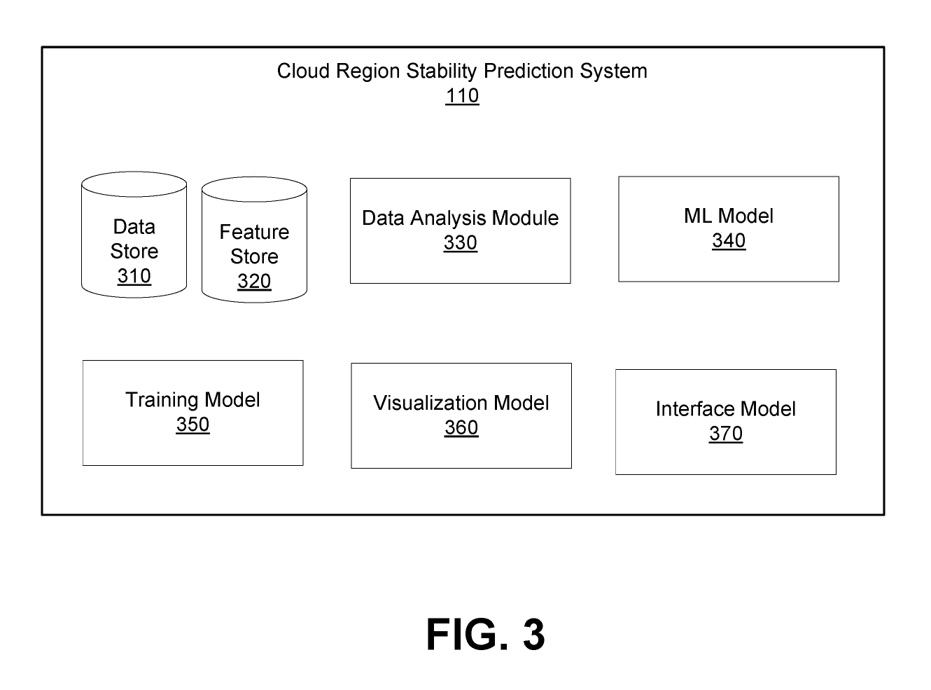

FIG. 3 illustrates an example architecture of the cloud region stability prediction system 110 ("the system") in accordance with one or more embodiments. The system 110 includes a data store 310, a feature store 320, a data analysis module 330, one or more machine learning models 340, a training module 350, a visualization module 360, and an interface module 370. The data store 310 is configured to store data collected from GPU instances (e.g., instances 122, 124, 132, 134) across different regions and cloud service providers (e.g., cloud service providers 120, 130). The data store 310 may be a relational database, such as (but not limited to) an SQL database or a PostgreSQL database. The data may include (but are not limited to) spot instance stability, tracking the availability and/or stability of instances over time; resource utilization, tracking CPU, memory, disk, and network usage of instances; instance interruptions, tracking when spot instances are interrupted by the cloud service provider; and provisional failures, tracking times when a request to provision resources at a spot instance fails.

The data analysis module 330 extracts features from the data in the data store 310. These features may include (but are not limited to), for each region and availability zone (AZ) of a cloud service provider, a number of interruptions that spot instances experience within a specific time window; an average reclamation time, which is an average duration from when a spot instance is reclaimed by the cloud service provider to when it becomes available again; insufficient capacity errors, which indicate failures due to resource unavailability rather than just general failed requests for spot instances; provisioning latency, which is the time required to provision or start a spot instance after making a request; and cost savings, tracking the cost savings from using spot instances compared to on-demand instances. The feature store 320 is configured to store features extracted from the data stored in the data store 310.

The data analysis module 330 is also configured to determine the number of available GPU instances and the total number of GPU instances in each availability zone (AZ) of a cloud service provider. While some regions have ample GPU availability, others face significant limitations. The data analysis module 330 identifies which regions offer GPU instances and retrieves data on the total number of GPU instances per region and/or AZ, as well as the number of instances currently available. Notably, the availability of GPU instances in a given region or AZ is related to the stability of spot instances. When GPU availability is low, the likelihood of spot instance recalls increases, as CSPs prioritize resource allocation based on demand.

The training module 350 is configured to use the features stored in the feature store 320 to train one or more machine-learning models 340. In some embodiments, the training module 350 is configured to train a machine-learning model 340 to predict cloud instance capacities, demand trends, and/or prices at a given region and a given cloud service provider. In some embodiments an ARIMA (Auto Regressive Integrated Moving Average) model is trained for forecasting future data points by considering past values in a time series. ARIMA models are well-suited for predicting cloud instance demand trends and/or prices. In some embodiments, a seasonal ARIMA model is trained to further account for seasonality in data. Given cloud usage and demand can exhibit seasonal patterns (e.g., higher demand during business hours), a seasonal ARIMA model may be able to provide more accurate forecasts for certain regions and/or cloud service providers, considering the seasonality in data. Linear regression, random forest regression, deep learning models, such as long short-term memory (LSTM) networks, gated recurrent units (GRU), and/or hybrid models may also be trained to forecast GPU instances' usage, demand, and cost over time.

The visualization module 360 is configured to generate a visual representation of the features or predicted results produced by the machine learning models 340. In some embodiments, this visualization takes the form of a heatmap that illustrates the stability or instability levels of different regions within a given cloud service provider. These levels may be represented using a color gradient, where darker shades indicate higher instability, and lighter shades indicate lower instability. Similarly, the same gradient approach can be applied to represent availability levels, where darker shades indicate higher unavailability, and lighter shades indicate greater availability.

Alternatively, or in addition, color coding may be used to indicate different levels of instability and availability. Green shades represent below-average instability levels, meaning instances in AZs or geographical regions with relatively high stability are associated with green colors. A darker green indicates greater stability (i.e., lower instability). On the other hand, red shades represent above-average instability levels, meaning instances in AZs or regions with higher instability are associated with red colors. The darker the red, the more unstable the region.

Similarly, regarding availability, darker green indicates higher availability, meaning the AZs or regions contain a greater number or percentage of available instances. Conversely, lighter green indicates lower availability. The same logic applies to red shades—darker red signifies lower availability, while lighter red suggests relatively better availability.

In some embodiments, the regions are not represented as contiguous areas, but scattered points across the map. A size of the point (e.g., a diameter of a circle) represents the number of availability zones in the corresponding region. In some embodiments, the visualization is interactive, enabling users to engage with it. For example, the user interface may detect a user interaction, such as hovering over or clicking a specific region of the heatmap to select the region. In response to the detection of this user interaction, a pop-up bubble may be generated, presenting additional metrics, predictions, or recommendations related to the selected region. The interface module 370 is configured to cause the visualization to be displayed at a client device of a user, and receive user interaction from the client device.

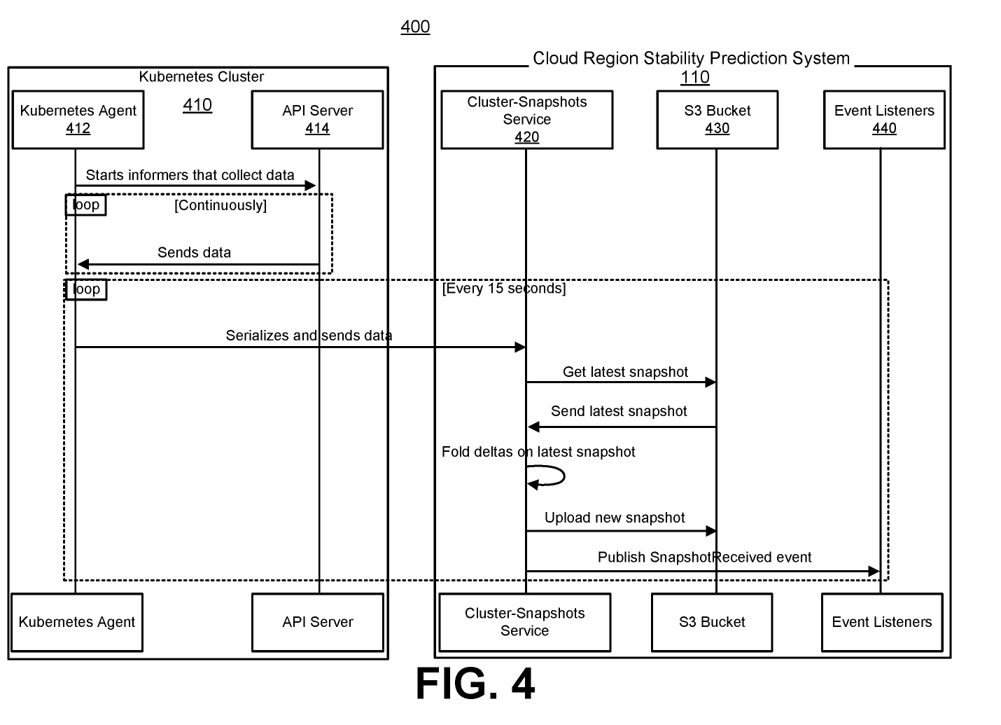

FIG. 4 illustrates an example environment 400 in which a Kubernetes agent 412 inside a Kubernetes cluster 410 is configured to serialize data and send the serialized data to system 110 in accordance with one or more embodiments. The Kubernetes cluster 410 is created on a spot instance of a cloud service provider. A Kubernetes cluster includes a Kubernetes agent 412 and an API server 414. The cloud region stability prediction system 110 includes a cluster snapshots service 420, an S3 bucket 430, and event listeners 440.

The API server 414 acts as a front-end, allowing users, different parts of the Kubernetes cluster 410 (such as the Kubernetes agent 412), and external components to communicate with the cluster 410. The Kubernetes agent 412 is configured to interact with the Kubernetes API server 414. The Kubernetes agent 412 causes the Kubernetes API server 414 to start informers that collect data. Informers are components in Kubernetes cluster 410 configured to watch registered events, such as (but not limited to) creation, updating, and deletion of resources. The Kubernetes API server 414 passes the collected data to the Kubernetes agent 412, which in turn passes the received data to the cluster snapshots service 420 of the system 110. As illustrated, the Kubernetes agent 412 is configured to serialize the received data and sends the serialized data to the cluster snapshots service 420 periodically, such as (but not limited to) every few seconds, e.g., 15 seconds, every few minutes, etc. The data may include (but are not limited to) data associated with spot instance stability, resource utilization, such as CPU, memory, disk, and network usage of GPU instances, instance interruptions, and provisional failures.

The cluster snapshots service 420 is configured to receive the time-series data from Kubernetes agents on different Kubernetes clusters (e.g., Kubernetes agent 412) on GPU instances across different regions and different cloud service providers. The cluster snapshots service 420 determines whether the new time-series data has changed since the last snapshot. If they are not the same, the cluster snapshots service 420 generates a new snapshot based on the new time-series data. Once the new snapshot is generated, the cluster snapshots service 420 sends it to the S3 bucket 430 for storage. S3 bucket 430 is a storage configured to archive historical snapshots received from the cluster snapshots service 420.

In some embodiments, as illustrated in FIG. 4, upon receiving new time-series data from the Kubernetes agent 412, the cluster snapshots service 420 sends a request for the latest previous snapshot archived at the S3 bucket 430, prompting the S3 bucket to fetch and forward the latest previous snapshot back to the service 420. At this point, the cluster snapshots service 420 possesses both the new time-series data and the latest previous snapshot. The service 420 is configured to compare the new time-series data with the latest previous snapshot to identify any changes in the new time-series data. In response to detecting changes, the cluster snapshots service 420 generates a new snapshot using the new time-series data and sends this new snapshot to the S3 bucket 430 for storage. Additionally, the cluster snapshots service 420 announces a snapshot-received event to the event listeners 440.

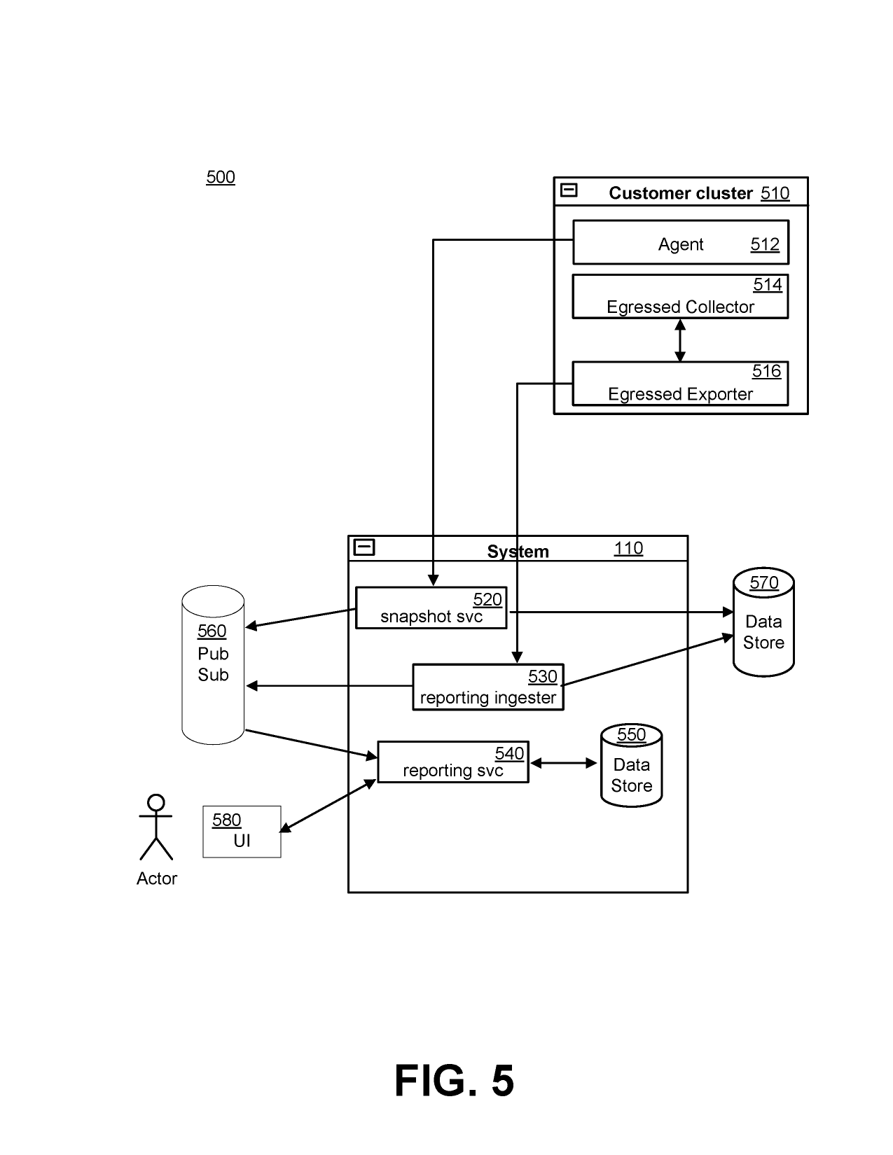

FIG. 5 illustrates another example environment 500, in which an agent within a cluster facilitates data collection in the cluster and data transmission to the cloud region stability prediction system 110 in accordance with one or more embodiments. This cluster 510 may be a Kubernetes cluster established on a spot instance within a cloud service provider. The cluster 510 includes an agent 512, an egress collector 514, and an egress exporter 516. The agent 512 causes the egress collector 514 to collect data. Upon collecting the data, the egress collector relays this data to both the egress exporter 516 and back to the agent 512.

The system 110 includes a snapshot service 520, a reporting ingester 530, a reporting service 540, and a database 550. The agent 512 is configured to serialize the data and send it to the snapshots service 520, which then passes the data to both a publish-subscribe (PubSub) system 560 and a storage 570 (such as a GCS database) for archive. The egress exporter 516 is configured to transmit the collected data to the reporting ingester 530. The data transmission from the agent 512 and/or the egress exporter 516 may be triggered by specific events, on a predetermined schedule or in real-time, based on their configurations. Upon receipt, the reporting ingester 530 undertakes a series of processing tasks, which may include (but not limited to) data validation, transformation (such as data formatting and aggregation), and enrichment (such as appending metadata). Post-processing, the reporting ingester 530 causes the data to be published in the PubSub system 560 and its archival in the storage 570, enabling both real time accessibility and persistent storage.

Upon receiving data from the reporting ingester 530, the PubSub system 560 broadcasts the data to assorted subscribers according to their respective subscriptions. The broadcasting is performed via the reporting service 540. The reporting service 540 is configured to process and/or aggregate the data from the PubSub system 560 to prepare it for reporting objectives. The reporting service 540 is configured to produce reports (including heatmaps) and to display these reports on a user interface (UI) 580. Moreover, the reporting service 540 causes the generated reports to be stored in a database 550 for archiving. In some embodiments, the database 550 may be an open source database, such as (but not limited to) a Mimir database. Alternatively, the database 550 may be a proprietary database provided by the system 110. In some embodiments, the database 550 allows the reporting service 540 to retrieve historical data or metrics for inclusion in reports or heatmaps or for trend analysis over time.

### GPU Instances Availability Optimization

Spot instances are virtual machines (VMs) offered by cloud providers when consumption of on-demand instances are low, but their availability is subject to supply and demand fluctuations. Most instances include CPUs and some instances include GPUs. However, the availability of GPUs is limited and depends on the cloud provider, region, and current demand. Unlike CPU-based instances, which are generally available across most regions, GPU instances may not be available in every region, and even in the regions with GPU instances, GPU instances have supply constraints.

Cloud computing environments, such as Kubernetes-managed infrastructures, manage computational resources such as CPU, GPUs, and/or memory. GPUs are particularly valuable for artificial intelligence (AI) and machine learning (ML) applications but suffer from limited availability due to competitive demand. Users or applications may struggle to efficiently select the most optimal cloud regions for GPU allocation due to a lack of clear comparative metrics across different cloud providers.

The system 110 provides a dynamic GPU availability tracking mechanism that visualizes GPU availability across multiple cloud regions and enables proactive provisioning of resources based on real-time and historical GPU utilization data. This mechanism addresses the technical problem of wasted computational efficiency and allocations by preventing users from attempting to provision GPU instances in regions where capacity is insufficient or where spot instances experience frequent interruptions.

In some embodiments, the system 110 determines a metric called the "availability ratio," which quantifies a number of GPU instances offered in a given cloud region relative to all possible GPU instances provided by the cloud provider. This metric provides a clear comparative insight into GPU accessibility across different cloud providers and geographic locations, assisting users and/or applications in making informed deployment decisions. By consulting the availability ratio before initiating provisioning requests, users avoid wasting computational allocations on regions where GPU resources are scarce or unavailable.

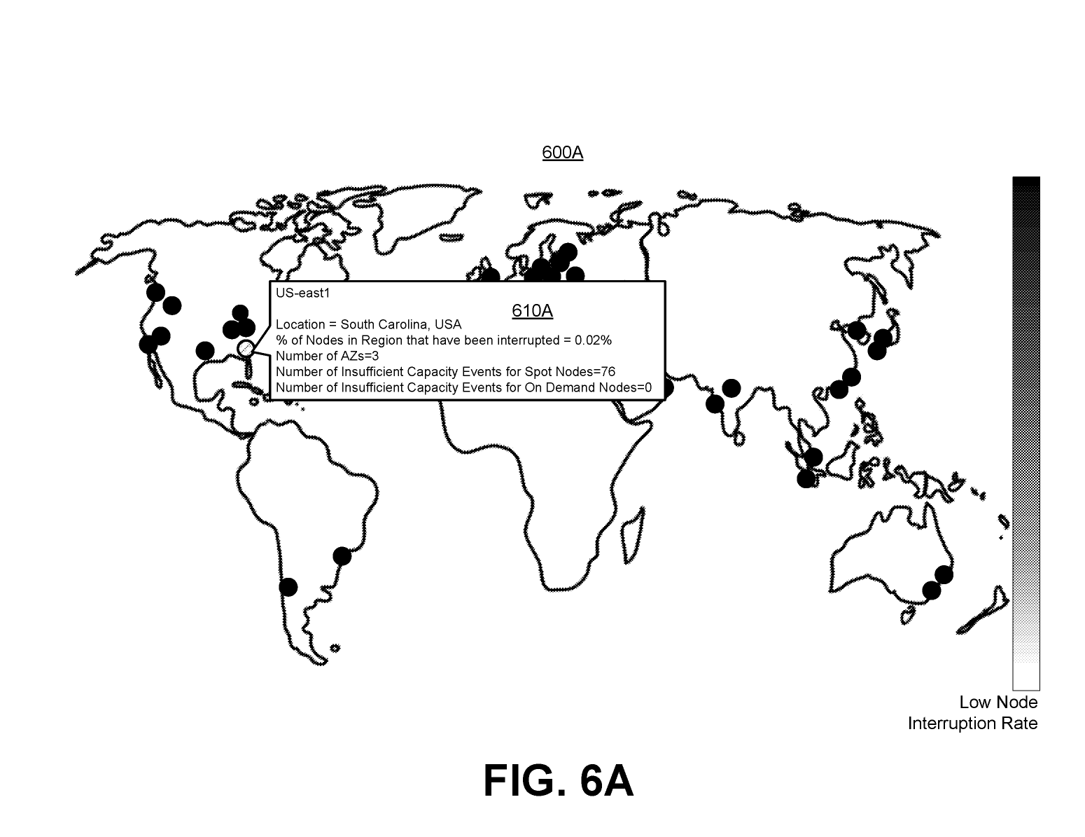

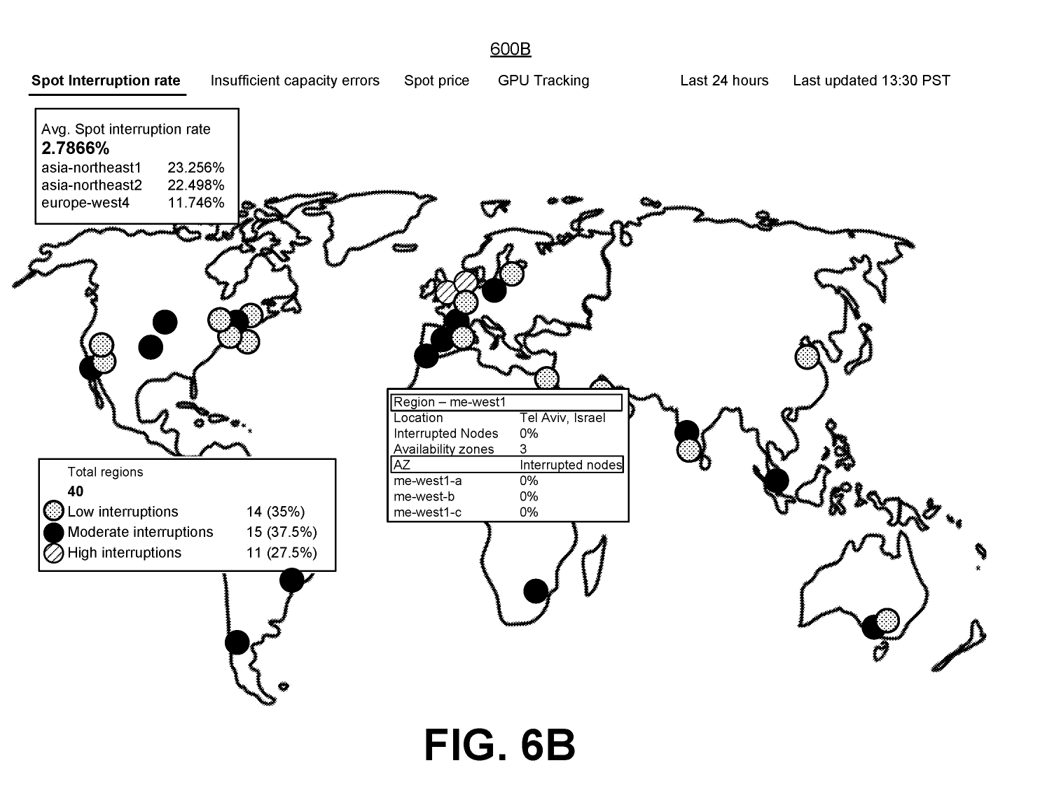

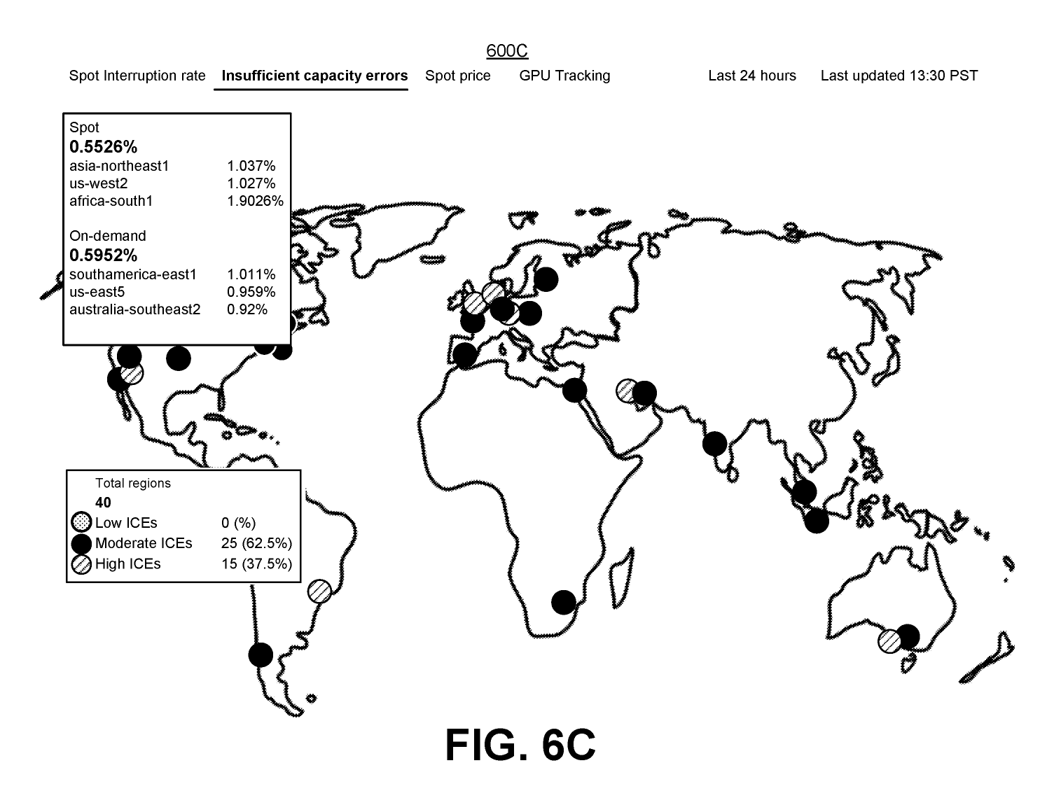

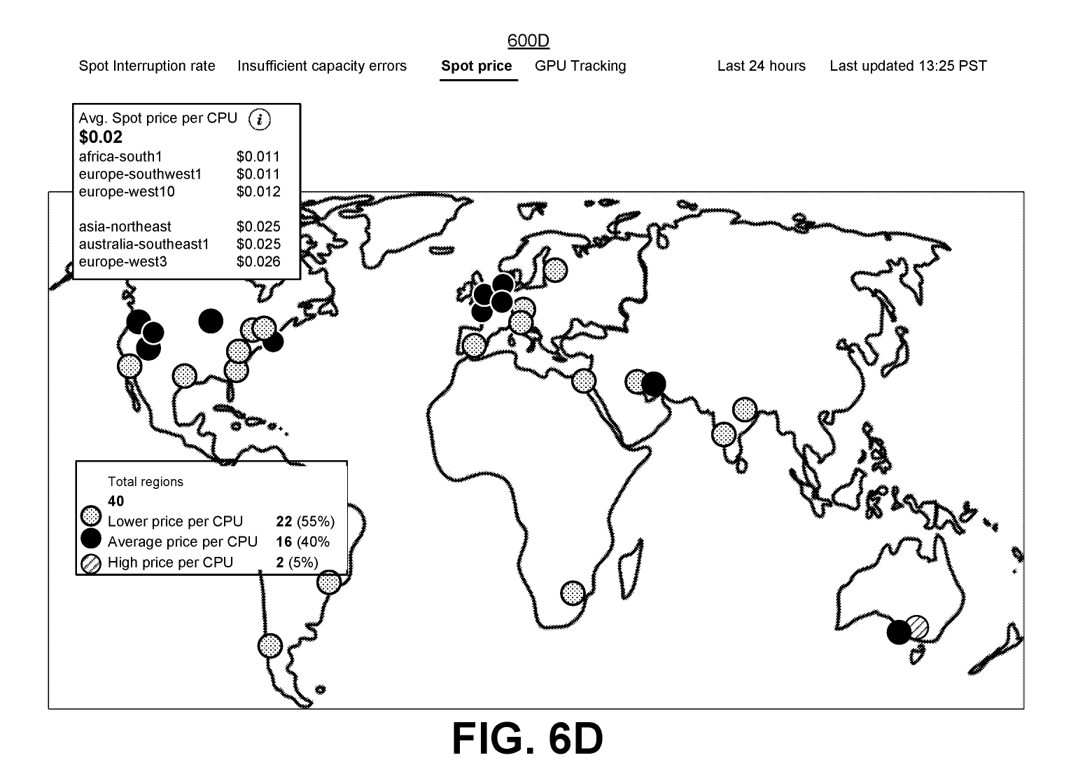

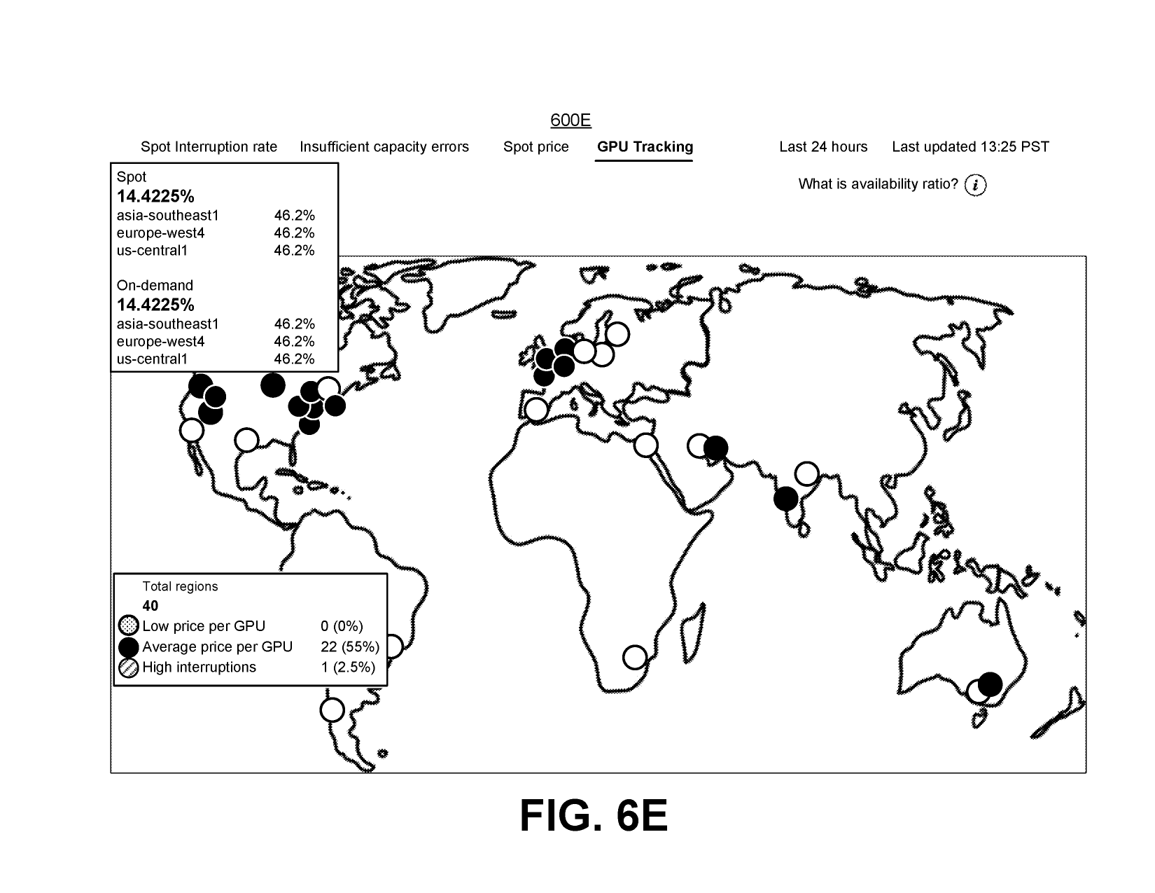

In some embodiments, the system 110 may also implement a dynamic color-coded mapping interface that updates in real time. In some embodiments, green zones indicate regions with higher availability, yellow zones represent moderately available, while red zones highlight areas with low availability. Gray zones indicate regions where no GPUs are currently available. This visual representation assists cloud users in selecting the most efficient regions for their compute-intensive workloads. Example GUIs are further described below with respect to FIG. 6A-6E.

In addition to real-time monitoring, in some embodiments, the system 110 is configured to incorporate predictive analytics for GPU availability based on historical demand trends. This predictive analytics feature enables proactive GPU allocation strategies and reduce resource bottlenecks, enhancing performance for AI/ML applications.

In some embodiments, the system 110 collects GPU availability data from multiple cloud service providers (CSPs), including AWS ®, Google Cloud Platform (GCP) ®, and Microsoft Azure ®. For each region of a CSP, the system 110 determines a number of GPU instance types accessible in the region of the CSP relative to the total number of possible GPU instance types. For example, if GCP offers 40 different GPU instances, but only 10 are offered in a given region, the availability ratio for that region would be 25%. In some embodiments, this metric is provided to users, allowing users to assess whether deploying in a given region is viable. Alternatively, the system 110 automatically selects a region based on requirement of an application and the metrics of different regions of the different CSPs.

In some embodiments, the system 110 interacts with public and/or private APIs provided by CSPs to gather real-time data about available compute instances, including GPU instances. These APIs are configured to return real-time metrics such as a number of GPUs currently available in a region and instance configuration. The instance configuration includes specifications of available GPU-enabled VM instances (e.g., memory, vCPUs, vGPUs, disk storage, etc.). In some embodiments, the system 110 performs API requests periodically, e.g., every minute, every 5 minutes, hourly, etc. The collected data is visualized in real time or near real time. In some embodiments, the collected data is stored and aggregated to detect trends in GPU availability over time.

In some embodiments, the system 110 performs API requests in response to detection of certain events, such as notifications from CSP event streams, such as AWS EventBridge, GCP Pub/Sub). For example, a user attempts to launch a GPU instance and fails due to an insufficient capacity error. In response to this failure event, the system 110 can re-query the API to confirm the latest availability.

As described above, each CSP divides its infrastructure into multiple geographic regions. For example, AWS operates in over 30 regions worldwide, GCP operates in about 40 regions worldwide, and Azure operates in over 60 regions worldwide. Each region includes multiple availability zones (AZs). These AZs are physically separate datacenters within a region that provide high availability, fault tolerance, and redundancy. In the same region, each AZ is isolated from failure in other AZs but is connected to them with low-latency networking. For example, each AZ has independent power, cooling, and networking to withstand failures in other AZs.

In some embodiments, to obtain AZ-specific data, the system 110 may perform API requests to obtain all regions for each CSP, and perform API requests iteratively to obtain all AZs for each region. For each AZ, the system 110 can perform API requests to obtain instance availability data associated with each AZ in each region.

In some embodiments, instead of querying regions or AZs sequentially, the system 110 is configured to send multiple API requests in parallel to reduce latency. In some embodiments, to reduce unnecessary API calls, the system 110 may request data for instance types that support GPUs at a first frequency, and request data for all other instance types in a second frequency different from the first frequency. In some embodiments, the system 110 prioritizes queries for regions with high demand or recent failures. For example, for a region with high demand or high recent failures, the system 110 performs API requests more frequently (e.g., at a first frequency) in this region; on the other hand, for another region with low demand or low recent failures, the system 110 performs API requests less frequently (e.g., at a second frequency lower than the first frequency) in this other region.

In some embodiments, the system 110 further integrates spot instance interruption tracking, insufficient capacity error reports, and real-time pricing data to provide a comprehensive GPU monitoring solution. These features empower users to make informed decisions when selecting cloud regions and/or CSPs for AI/ML workloads, helping users balance resource consumption efficiency and availability.

In some embodiments, the system 110 is configured to automatically select an optimal region to provision GPUs based on real-time availability and user-defined constraints. The user-defined constraints may include (but are not limited to) budget limits, latency requirements, energy efficiency preferences, compliance with regional data governance policies, and/or preferred CSPs. By automatically selecting optimal regions, the system 110 prevents users from wasting computational allocations on suboptimal regions where provisioning attempts would likely fail or result in frequent interruptions.

In some embodiments, the system 110 integrates machine learning algorithms to predict GPU availability trends based on historical usage patterns. The system 110 is configured to proactively allocate resources, minimizing downtime and optimizing compute resource management. Given the widespread adoption of GPUs for AI/ML applications and the increasing constraints on GPU availability, the embodiments described herein provide a valuable tool for optimizing resource allocation in cloud computing environments.

As a concrete example use case, consider an enterprise deploying a large-scale machine learning training workload requiring 50 H100 GPU instances. Without the system 110, the enterprise might attempt to provision these instances in the us-east1 region based solely on geographic proximity to their data center. However, if us-east1 currently experiences high demand and low GPU availability (e.g., an availability ratio of 15% and a spot interruption rate of 25%), the provisioning requests would likely fail or result in frequent spot instance recalls. Each failed provisioning attempt wastes time and computational allocations, as the enterprise must repeatedly submit requests, monitor for capacity, and potentially reconfigure workloads. Furthermore, if spot instances are successfully provisioned but then interrupted within hours, the training job must be checkpointed and restarted, wasting the computational work already performed and delaying project timelines. By consulting the system 110 before initiating provisioning, the enterprise can identify that the europe-west4 region currently has an availability ratio of 65% and a spot interruption rate of only 5%. The system 110 recommends europe-west4 as the optimal region for this workload. By provisioning in europe-west4 instead of us-east1, the enterprise avoids multiple failed provisioning attempts, reduces the likelihood of spot instance interruptions, and completes the training job more efficiently. This concrete example demonstrates how the system 110 prevents wasted computational efficiency and allocations by directing users to regions where GPU resources are available and stable, thereby solving the technical problem of inefficient resource allocation in distributed cloud environments.

### Example Graphical User Iinterface GUI

FIG. 6A illustrates an example user interface (UI) 600A generated based on the data collected from GPU instances across different regions of a cloud service provider (e.g., GCP) in accordance with one or more embodiments. The UI 600A includes a map showing different regions where GCP provides GPU instances. Notably, these regions are not as contiguous areas but as scattered points, each marked by a dot. In some embodiments, a diameter of each dot represents a capacity at that location, for instance, a number of GPU instances available at the location or the number of availability zones available at the location. In some embodiments, a color of each dot represents a stability level of the GPU instances at the location. In some embodiments, the map is interactive. For example, when a mouse hovers over a region or clicks on a region, the region changes its color, and the changed color represents the stability or instability of GPU instances in the region. Alternatively, or in addition, responsive to receiving a user interaction, additional metrics associated with the region are displayed as a pop-up window 610A, as shown in FIG. 6A.

Additionally, as the system 110 continuously monitors the stability levels of GPU instances across various regions, the UI 600A is dynamically updated to reflect changes in these stability levels. For instance, in some embodiments, there are rankings panels in the map that contain the top three most and least interrupted regions. These rankings fluctuate constantly over time. Similarly, changes in the stability levels of a region can result in modifications to the region's color on the map. Furthermore, other metrics specific to each region are subject to change as well. Consequently, when the UI 600A is interacted with at different times, it displays metrics that are relevant to the current moment, providing users with up-to-date information.

By dynamically representing the capacity and stability of GPU instances in various regions through visual means (varying dot diameters for capacity and colors for stability) and updating these in real-time as conditions change, the UI provides an immediate, intuitive understanding of complex data that was not previously available. This improvement in data visualization and interaction can enhance decision-making processes for entities and applications to manage cloud resources, representing a specific improvement in the technology of cloud service management.

FIG. 6B illustrates an example GUI 600B, displaying spot interruption rates across different regions for a CSP (e.g., GCP) in accordance with one or more embodiments. GUI 600B includes an interactive map displaying spot interruption data across different regions. Each region is represented by a color-coded dot, e.g., green indicates low interruptions, orange indicates moderate interruptions, and red indicates high interruptions. A user can interact with the map, e.g., hovering over or clicking a dot corresponding to a specific region to see the metrics of that specific region. For example, when a user interacts with the dot corresponding to the me-west1 region (Tel Aviv, Israel), metrics associated with availability zones in that region pop up. Here, there are three availability zones (namely, me-west1-a, me-west1-b, and me-west1-c) in the me-west1 region.

The GUI 600B also includes a metric panel that shows average spot interruption rate and top three regions with the highest spot interruptions. The GUI 600B also includes a total regions breakdown. For example, total 40 regions (32.5%) of GCP are monitored. The 40 regions are categorized by interruption levels, including 13 regions (32.5%) with low interruptions (green), 11 regions (27.5%) with moderate interruptions (orange), and 16 regions (40%) with high interruptions (red). Notably, this GUI 600B shows 40 regions of GCP. Users can toggle the drop down list to select a different CSP, e.g., AWS or Azure to see their regions and spot interruptions data.

FIG. 6C illustrates an example GUI 600C displaying insufficient capacity errors (ICEs) across different regions of a CSP, in accordance with one or more embodiments. The GUI 600C includes an interactive map displaying ICE levels per region. Each region is represented by a color-coded dot, indicating ICE severity, e.g., green indicating low ICEs, orange indicating moderate ICEs, and red indicating high ICEs. Users can interact with the map to select a particular region to see its ICE metrics. For example, in response to user interaction with me-west1 region (Tel Aviv, Israel), a pop-up window is displayed to provide detailed ICE metrics for this region. The pop-up window shows that spot nodes ICE rate is 0.84%, and on-demand nodes ICE is 1%. For each region, there are multiple AZs. For example, here in me-west1 region, there are three AZs, me-west1-a, me-west1-b, me-west1-c, each has their corresponding spot ICE rate and on-demand ICE rate.

The GUI 600C also includes metric panels on the left. The panel displays average spot instance ICE rate and top three regions with the highest spot instance ICE rates. A top left panel also displays an average on-demand instance ICE rate and top three regions with the highest on-demand instance ICE rate. A bottom left panel displays total regions breakdown, including total 40 regions, and ICE distribution across regions, e.g., 0 region with low ICEs (0%), 29 regions with moderate ICEs (72.5%), and 11 regions with high ICEs (27.5%).

FIG. 6D illustrates an example GUI 600D displaying spot instance pricing per CPU across different GCP regions, in accordance with one or more embodiments. The GUI 600D includes an interactive map displaying spot CPU prices per region. Each region is represented by a color-coded dot, e.g., green indicating low spot price per CPU, orange spot indicating average spot price per CPU, and red spot indicating high spot price per CPU. In response to users interacting with a specific region, a pop-up window is displayed providing spot pricing for the specific region. For example, as illustrated, a user interacted with the me-west1 region (Tel Aviv, Israel), the spot pricing for this region including all AZs in the region is displayed.

The GUI 600D also includes panels on the left. Top left panel displays average spot price per CPU and top three regions with the lowest and highest spot prices. Bottom left panel displays total monitored regions and spot price distribution across regions, e.g., 22 regions with low price per CPU, 16 regions with average price per CPU, and 2 regions with high price per CPU.

FIG. 6E illustrates an example GUI 600E displaying GPU availability and pricing across different GCP regions, in accordance with one or more embodiments. The GUI 600E includes an interactive map displaying GPU availability and pricing across cloud regions. Each region is represented by a color-coded dot, e.g., green indicating low GPU pricing (more affordable), orange indicating average GPU pricing, and red indicating high GPU pricing (scarce availability). Users can interact with each region to see the region's GPU stats. In response to user interacting with a specific region, a popup window is displayed, presenting the region's GPU availability ratio and pricing breakdown for different GPUs under on-demand and GPU instances. As illustrated, the asia-south1 region (Mumbai, India) is selected, and the popup window shows the availability ratio as 19.2%, and GPU pricing breakdown. The GPU pricing breakdown includes multiple different types of GPUs, such as H100 GPU, L4 GPU, and T4 GPU. The on-demand pricing for H100 GPU is $81.51, and spot pricing for H100 GPU is $57.49, and so on.

The GUI 600E also includes panels on the left displaying various metrics. A top left panel shows an overall spot GPU availability rate and top three regions with the highest availability; and an overall on-demand GPU availability rate and regions with the highest availability. A bottom left panel displays total monitored regions and GPU price distribution across regions, e.g., 0 region with low price per GPU, 22 regions with average price per GPU, and 1 region with high price per GPU.

In some embodiments, the user interfaces illustrated in FIGS. 6A-6E include interactive controls that enable automated resource management based on the displayed metrics. For example, the GUI may include a selectable option, such as a button or menu item, that allows a user to initiate automatic migration of workloads to recommended GPU clusters. Upon selection of this option, the system 110 automatically provisions GPU instances in the recommended geographic region and migrates the user's computational workloads from a current region to the recommended region. This migration may include transferring containerized applications, checkpointing running processes, and reconfiguring network connections to ensure continuity of operations. The system 110 performs these migration operations without requiring manual intervention from the user, thereby reducing the time and effort required to optimize GPU resource allocation.

In some embodiments, the system 110 is configured to automatically detect scenarios that render a current GPU deployment suboptimal and, in response to such detection, surface the user interface to present migration recommendations. The system 110 continuously monitors the metrics associated with GPU availability for the geographic region and availability zone where a user's workloads are currently deployed. When the system 110 detects that one or more metrics have degraded beyond predefined threshold values, the system 110 determines that the current deployment has become suboptimal. For example, the system 110 may detect that the availability ratio in the current region has fallen below 20%, that the spot interruption rate has exceeded 15%, that the insufficient capacity error rate has risen above 10%, or that a combination of these metrics indicates deteriorating conditions. Upon detecting such scenarios, the system 110 automatically generates and displays the user interface illustrated in FIGS. 6A-6E, highlighting the suboptimal conditions in the current region and presenting recommendations for alternative regions or availability zones with superior metrics. This proactive notification mechanism enables users to respond quickly to changing cloud conditions, migrating workloads to more stable and available regions before experiencing service disruptions or provisioning failures. The automatic surfacing of the user interface in response to detected suboptimal conditions reduces the need for manual monitoring and allows users to maintain optimal GPU resource allocation without constant oversight.

The system 110 continuously monitors the metrics associated with GPU availability by periodically querying the data store 310 and feature store 320 to retrieve current values for availability ratio, spot interruption rate, insufficient capacity error rate, and other relevant metrics for the geographic region and availability zone where the user's workloads are currently deployed. The monitoring occurs at regular intervals, such as every minute, every five minutes, or every fifteen minutes, depending on the configured monitoring frequency. In some embodiments, the system 110 subscribes to real-time event streams from the cloud service providers, such as AWS EventBridge or GCP Pub/Sub, to receive immediate notifications of changes in GPU availability or spot instance interruptions, as described in paragraph . The system 110 compares the current metric values against predefined threshold values to detect degradation in GPU availability or stability.

When the system 110 detects that one or more metrics have degraded beyond the predefined threshold values, the system 110 determines that the current deployment has become suboptimal. The detection of suboptimal conditions triggers an automated response by the system 110. The system 110 generates the graphical user interface illustrated in FIGS. 6A-6E, populating the visualization with current data that highlights the degraded metrics in the current region. The system 110 automatically surfaces the graphical user interface by transmitting display instructions to the client device where the user's workloads are managed, causing the interface to appear on the user's display without requiring the user to manually navigate to the interface or request the information. In some embodiments, the system 110 sends a notification to the user through email, SMS, or an in-application alert, informing the user that the current GPU deployment has become suboptimal and that recommendations are available for review. The automatically surfaced user interface presents the visualization of GPU availability across the plurality of geographic regions, with visual indicators that distinguish the current region's degraded metrics from the superior metrics available in alternative regions. The user interface includes the recommended GPU allocation, identifying one or more alternative geographic regions that offer improved availability ratios, lower spot interruption rates, or reduced insufficient capacity error rates compared to the current region.

In some embodiments, the system 110 prioritizes recommendations for workloads that would experience the most significant disruption from GPU instance instability. The system 110 analyzes characteristics of computational workloads to identify those with long estimated time to completion (ETA), such as deep learning model training jobs, large-scale simulations, or batch processing tasks that require hours or days to complete. For workloads with long ETAs, spot instance interruptions present a particularly severe problem because the interruption may occur before the workload completes its task, forcing the workload to restart from the beginning or from the last checkpoint. This restart wastes all computational work performed between the last checkpoint and the interruption, resulting in lost time and wasted GPU allocations. The system 110 determines an estimated completion time for each workload based on historical execution data, user-provided estimates, or real-time monitoring of task progress. When the estimated completion time exceeds a threshold value (e.g., exceeds 2 hours, 6 hours, or 24 hours), the system 110 classifies the workload as high-priority for stable GPU allocation. For these high-priority workloads, the system 110 weights the recommendations more heavily toward regions with low spot interruption rates and high availability ratios, even if those regions have slightly higher pricing. By directing long-running workloads to the most stable regions, the system 110 minimizes the likelihood that these workloads will be interrupted before completion, thereby preventing the waste of computational resources that would result from forced restarts. This prioritization mechanism ensures that workloads most vulnerable to disruption receive the most stable GPU allocations, optimizing overall computational efficiency across the cloud environment.

The system 110 determines the estimated time to completion for a computational workload by analyzing multiple data sources. In some embodiments, the system 110 retrieves historical execution data from previous runs of similar workloads, including the time required to complete training epochs, simulation iterations, or batch processing cycles. The system 110 may access metadata associated with the workload, such as the number of training samples, model architecture complexity, dataset size, or computational intensity, and use this metadata to estimate completion time based on known performance characteristics of the GPU instance type being used. In some embodiments, the system 110 receives user-provided estimates of expected completion time, which may be specified when the workload is submitted or configured. Alternatively, the system 110 monitors task progress in real-time by tracking metrics such as the percentage of training epochs completed, the rate of progress through a dataset, or the number of simulation steps executed per unit time, and extrapolates the remaining time to completion based on the observed progress rate.

When the system 110 determines that a workload is classified as high-priority for stable GPU allocation, the system 110 evaluates the spot interruption rate for the geographic region where the workload is currently deployed. The spot interruption rate is calculated based on historical data collected from agents deployed on GPU instances across the region, as described in paragraphs and . The system 110 compares the spot interruption rate for the current region against a predetermined interruption threshold, which may be configured based on the acceptable risk level for the workload. For example, the predetermined interruption threshold may be set at 10%, 15%, or 20%, depending on the criticality of the workload and the tolerance for interruptions. When the spot interruption rate in the current region exceeds the predetermined interruption threshold, the system 110 determines that the current region presents an unacceptable risk of interruption for the high-priority workload.

In response to determining that the workload is high-priority and that the current region has an excessive spot interruption rate, the system 110 identifies alternative geographic regions that provide more stable GPU allocations. The system 110 queries the data store 310 and feature store 320 to retrieve spot interruption rates for all available geographic regions across the plurality of cloud service providers. The system 110 filters the available regions to identify those having a spot interruption rate below the predetermined interruption threshold. In some embodiments, the system 110 further evaluates additional metrics for the candidate regions, such as GPU availability ratio, insufficient capacity error rate, and pricing, to select the optimal alternative region. The system 110 ranks the candidate regions based on a weighted combination of stability metrics and availability metrics, prioritizing regions that offer both low interruption rates and high GPU availability. The system 110 selects the highest-ranked region as the recommended destination for migrating the workload.

The system 110 outputs the recommendation for GPU allocation through the graphical user interface described in paragraphs through . The recommendation includes an identification of the second geographic region, along with supporting metrics that justify the recommendation, such as the spot interruption rate, GPU availability ratio, and estimated cost difference compared to the current region. In some embodiments, the recommendation includes a detailed comparison showing the spot interruption rate in the current region versus the recommended region, the estimated time savings from avoiding interruptions, and the projected completion time in each region. The user interface may display the recommendation as a notification, alert, or highlighted suggestion within the visualization of GPU availability across geographic regions. In some embodiments, the recommendation includes an interactive control that allows the user to initiate automatic migration of the workload to the recommended region, as described in paragraph . The system 110 may also automatically initiate the migration without user intervention when operating in the fully automated mode described in paragraph .

In some embodiments, the system 110 operates in a fully automated mode where the user interface is bypassed entirely. In this mode, the system 110 continuously monitors GPU availability metrics across multiple cloud service providers and geographic regions, and automatically migrates workloads to optimal regions when predefined conditions are met. For example, the system 110 may be configured to automatically migrate workloads when the availability ratio in a current region falls below a threshold value (e.g., below 20%), when the spot interruption rate exceeds a threshold value (e.g., above 15%), or when a combination of availability and pricing metrics indicates that a different region would provide superior performance or cost efficiency. The automated migration is performed transparently to the user's applications, ensuring that computational workloads continue to execute without interruption while benefiting from improved GPU availability and stability. This fully automated approach eliminates the need for manual monitoring and decision-making, allowing users to focus on their core computational tasks while the system 110 handles resource optimization in the background.

### Example Method for Collecting and Processing Data Related to GPU instances

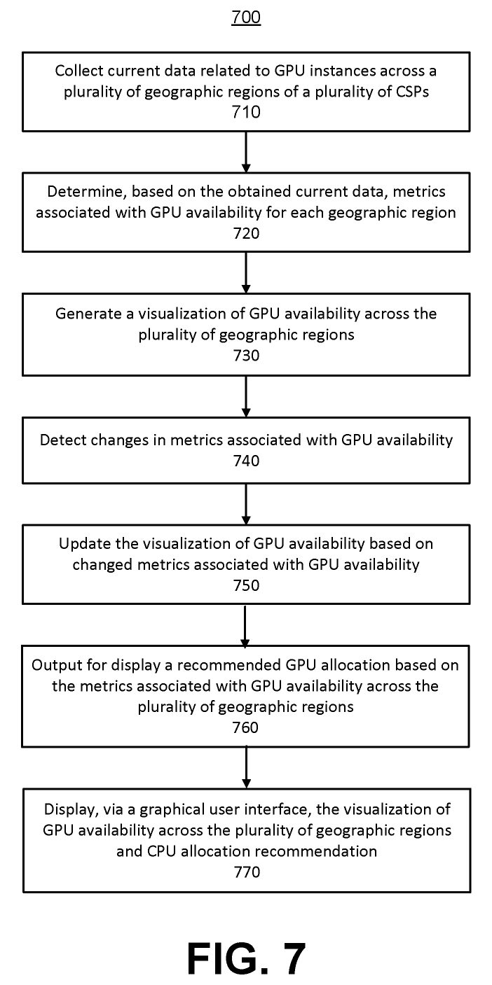

FIG. 7 is a flowchart of one embodiment of a method 700 for collecting and processing data related to GPU instances and generating a heatmap based on the processed data. In various embodiments, the method includes different or additional steps than those described in conjunction with FIG. 7.Further, in some embodiments, the steps of the method may be performed in different orders than the order described in conjunction with FIG. 7.The method described in conjunction with FIG. 5 may be carried out by the cloud region stability prediction system 110 in various embodiments, while in other embodiments, the steps of the method are performed by any online system capable of collecting and processing data related to GPU instances.

The system 110 collects 710 current data related to GPU instances across a plurality of geographic regions of a plurality of CSPs. The data related to GPU instances may include (but is not limited to) a number of available GPU instances in each geographic region or AZ, a total number of GPU instances offered in each geographic region or AZ. In some embodiments, each geographic region or AZ offers multiple types of GPU instances. The data includes available and total numbers for each type of GPU instances. The data may also include spot instance pricing and on-demand instance pricing for different types of GPU instances. The data may also include GPU spot instance interruptions and failures, and/or insufficient capacity errors related to GPU provisioning.

In some embodiments, the data may be obtained via agents deployed on provisioned GPU instances, which may be part of Kubernetes clusters. These agents can collect operational metrics, such as (but not limited to) stability of GPU spot instances, resource utilization (GPU, CPU, memory, disk I/O, and network usage), spot instance interruptions and provisioning failures. In some embodiments, the agents serialize and send data periodically (e.g., every few seconds or minutes to the system 110).

Alternatively, or in addition, the data may be obtained via API queries to CSPs. In some embodiments, the system 110 interacts with pubic and private APIs provided by CSPs such as AWS ®, GCP ®, and Microsoft Azure ®. In response to the API queries, these APIs return real-time metrics, including (but not limited to) number of a GPU instances currently available in a region or AZ, instance configurations (e.g., memory, vCPU, vGPU, disk storage), pricing details for spot and/or on-demand instances, and/or in sufficient capacity errors (ICEs). In some embodiments, the system 110 sends API queries at a predetermined intervals (e.g., every minute, every 5 minutes, hourly) to maintain up-to-date data. In some embodiments, the system listens to event notification from CSPs. When a GPU provisioning request fails due to insufficient capacity, the system triggers an API request to retrieve the lates availability data.

The system 110 determines 720, based on the obtained current data, metrics associated with GPU availability for each geographic region. The metrics associated with GPU availability include GPU availability ratio, which measures the percentage of GPU instance type available in a region or AZ relative to the total GPU types offered in that region or AZ by the CSP. For example, if a CSP offers 40 GPU instance type in a particular region, but only 10 are available (the remaining 30 are in use), the availability ratio is 25% (=10/40).

In some embodiments, metrics associated with GPU stability are also determined. The metrics associated with GPU stability include (but are not limited to) insufficient capacity error (ICE) rate, spot instance interruption rate, reclamation time, provisioning latency, and/or region stability score. ICE rate measures how often GPU provisioning requests fail due to lack of available resources. For example, if 50 out of 500 GPU requests fail due to insufficient capacity, the ICE rate is 10%. Spot instance interruption rate tracks how frequently spot GPU instances are reclaimed or terminated by the cloud provider due to demand fluctuations. The reclamation time measures the time between a GPU instance being terminated and when it becomes available again, which helps users and applications to estimate how long they may have to wait before retrying a GPU spot instance provisioning request. Provisioning latency is a time taken from requesting a GPU instance to when it is successfully launched. It helps measure GPU instances availability. For example, if the CSP needs to recall a spot instance before provisioning an on-demand instance, the time required to launch the on-demand instance will be longer than when instances are readily available. A region stability score may be a composite metric based on GPU availability, ICE rate, and spot interruptions to determine overall GPU stability in a region. Higher stability score indicates more reliable region for GPU workloads.

In some embodiments, metrics associated with pricing are also determined, including (but not limited to) on-demand GPU pricing, spot GPU pricing, price difference between on-demand and spot GPUs, and cost efficiency metrics. On-demand GPU pricing may be the cost per hour for running an on-demand GPU instance. Spot GPU pricing may be the current price for spot GPU instances, which fluctuates based on demand. Price difference between on-demand and spot GPUs can help users assess potential cost savings by using spot GPUs. Cost efficiency metrics may be a composite metric determined by considering price and stability for selecting an optimal region. For example, a region with low spot GPU prices but high interruptions may not be the most effective region.

The system 110 generates 730 a visualization of GPU availability across the plurality of geographic regions. The system 110 detects 740 changes in metrics associated with GPU availability. In response to detecting changes in metrics, the system 110 updates 750 the visualization of GPU availability based on changed metrics associated with GPU availability.

The system 110 outputs 760 for display a recommended GPU allocation based on the metrics associated with GPU availability across the plurality of geographic regions. The system 110 displays 770, via a graphical user interface, the visualization of GPU availability across the plurality of geographic regions. For example, the recommendations may be the top 3 regions or AZs that have the best availability metrics, stability metrics and/or pricing metrics.

In some embodiments, the collected data is structured into time-series format, and stored at regular intervals. The stored historical data can later be used for trend analysis and predictive modeling. In some embodiments, system 110 may train machine learning models using historical GPU availability and reliability data to forecast GPU availability trends. Such prediction may also be visualized and presented to user for review. Such prediction may also be used to generate recommendations.

### Example Computing System

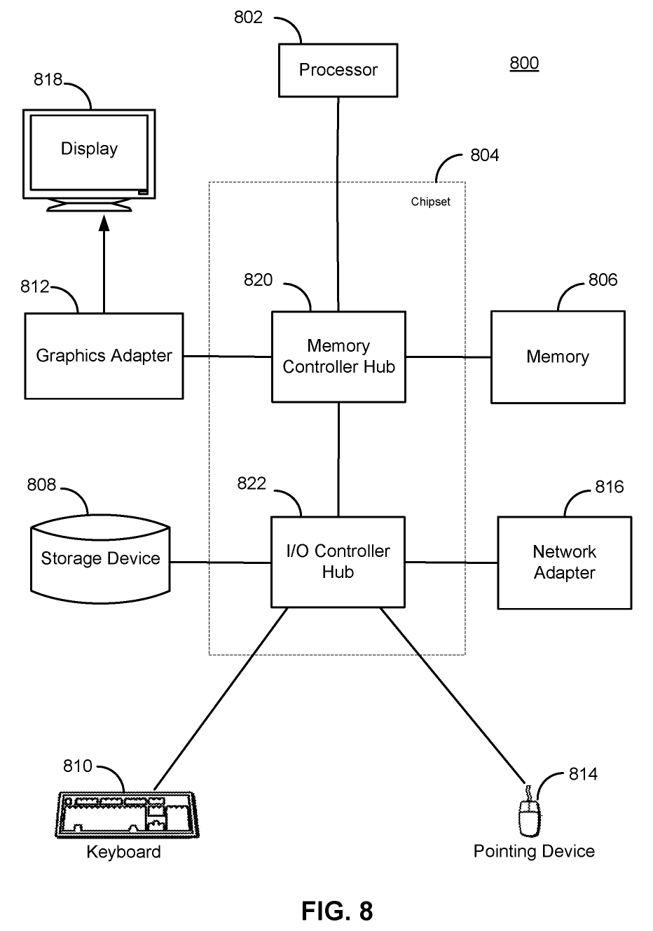

FIG. 8 is a block diagram of an example computer 800 suitable for use in the networked computing environment 100 of FIG. 1. The computer 800 is a computer system and is configured to perform specific functions as described herein. For example, the specific functions corresponding to cloud region stability prediction system 110 or cloud service provider 120, 130 be configured through the computer 800.

The example computer 800 includes a processor system having one or more processors 802 coupled to a chipset 804.The chipset 804 includes a memory controller hub 820 and an input/output (I/O) controller hub 822.A memory system having one or more memories 806 and a graphics adapter 812 are coupled to the memory controller hub 820, and a display 818 is coupled to the graphics adapter 812.A storage device 808, keyboard 810, pointing device 814, and network adapter 816 are coupled to the I/O controller hub 822.Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802.The pointing device 814 is a mouse, track ball, touchscreen, or other types of a pointing device and may be used in combination with the keyboard 810 (which may be an on-screen keyboard) to input data into the computer 800.The graphics adapter 812 displays images and other information on the display 818.The network adapter 816 couples the computer 800 to one or more computer networks, such as network 140.

The types of computers used by the entities and the AI automation system 80 of FIGS. 1 through 7 can vary depending upon the embodiment and the processing power required by the enterprise. For example, the AI automation system 80 might include multiple blade servers working together to provide the functionality described. Furthermore, the computers can lack some of the components described above, such as keyboards 810, graphics adapters 812, and displays 818.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for visualizing stability of GPU instances in a cloud computing environment, the method comprising:
obtaining current data related to GPU instances across a plurality of geographic regions of a plurality of cloud service providers;
determining, based on the obtained current data, metrics associated with GPU availability for each geographic region;
generating a visualization of GPU availability across the plurality of geographic regions, wherein each region is dynamically assigned a visual indicator based on its corresponding metrics, the visual indicator distinguishing different levels of metrics associated with GPU availability;
in response to detecting changes in metrics associated with GPU availability, updating the visualization of GPU availability based on changed metrics associated with GPU availability;
outputting for display a recommended GPU allocation based on the metrics associated with GPU availability across the plurality of geographic regions, the recommended GPU allocation including at least one recommended geographic region of at least one cloud service provider for GPU allocation;
displaying, via a graphical user interface, the visualization of GPU availability across the plurality of geographic regions and the GPU allocation recommendation.

2. The method of claim 1, wherein the metrics associated with GPU availability include availability ratios, which is a fraction of available GPU instances relative to a total number of GPU instances offered in a geographic region by a cloud service provider.

3. The method of claim 1, wherein each geographic region includes one or more availability zones, the method further comprising:
determining metrics associated with GPU availability for each of the one or more availability zones in each geographic region.

4. The method of claim 1, wherein each geographic region includes one or more different types of GPU instances, the method further comprising:
determining metrics associated with GPU availability for each of the one or more different types of GPU instances in each geographic region.

5. The method of claim 1, wherein the visualization includes a map showing the plurality of geographical regions color-coded representing different levels of GPU availability based on the metrics.

6. The method of claim 5, the method further comprising:
receiving a user selection of a region on the map; and
displaying the metrics related to GPU availability of the selected region.

7. The method of claim 1, the method further comprising:
predicting metrics associated with future GPU availability for each geographic region using a machine learning model trained on historical data related to GPU instances in the plurality of geographic regions, wherein the recommendation is further based on the predicted metrics associated with future GPU availability.

8. The method of claim 1, wherein the metrics associated with GPU availability in the plurality of geographic regions include stability of spot GPU instances, and the recommendation for GPU allocation is further based on stability of spot GPU instances in each geographic region.

9. The method of claim 1, further comprising:
determining an estimated time to completion for a computational workload deployed on a GPU instance in a first geographic region;
determining that the estimated time to completion exceeds a threshold value;
in response to determining that the estimated time to completion exceeds the threshold value, classifying the computational workload as high-priority for stable GPU allocation;
determining that the first geographic region has a spot interruption rate exceeding a predetermined interruption threshold;
in response to determining that the computational workload is classified as high-priority and that the first geographic region has a spot interruption rate exceeding the predetermined interruption threshold, identifying a second geographic region having a spot interruption rate below the predetermined interruption threshold; and
outputting the recommendation for GPU allocation, wherein the recommendation includes the second geographic region as a recommended region for migrating the computational workload.

10. The method of claim 1, further comprising:
continuously monitoring the metrics associated with GPU availability for a third geographic region in which a user's computational workload is currently deployed;
detecting that one or more of the metrics associated with GPU availability for the third geographic region have degraded beyond a predefined threshold value;
in response to detecting that the one or more metrics have degraded beyond the predefined threshold value, determining that the current deployment has become suboptimal; and
in response to determining that the current deployment has become suboptimal, automatically surfacing the graphical user interface to present the visualization of GPU availability and the recommended GPU allocation.

11. A non-transitory computer-readable medium comprising memory with instructions encoded thereon for visualizing stability of GPU instances in a cloud computing environment, the instructions, when executed, causing the one or more processors to perform operations comprising:
obtaining current data related to GPU instances across a plurality of geographic regions of a plurality of cloud service providers;
determining, based on the obtained current data, metrics associated with GPU availability for each geographic region;
generating a visualization of GPU availability across the plurality of geographic regions, wherein each region is dynamically assigned a visual indicator based on its corresponding metrics, the visual indicator distinguishing different levels of metrics associated with GPU availability;
in response to detecting changes in metrics associated with GPU availability, updating the visualization of GPU availability based on changed metrics associated with GPU availability;
outputting for display a recommended GPU allocation based on the metrics associated with GPU availability across the plurality of geographic regions, the recommended GPU allocation including at least one recommended geographic region of at least one cloud service provider for GPU allocation;
displaying, via a graphical user interface, the visualization of GPU availability across the plurality of geographic regions and the GPU allocation recommendation.

12. The non-transitory computer-readable medium of claim 11, wherein the metrics associated with GPU availability include availability ratios, which is a fraction of available GPU instances relative to a total number of GPU instances offered in a geographic region by a cloud service provider.

13. The non-transitory computer-readable medium of claim 11, wherein each geographic region includes one or more availability zones, the operations further comprising:
determining metrics associated with GPU availability for each of the one or more availability zones in each geographic region.

14. The non-transitory computer-readable medium of claim 11, wherein each geographic region includes one or more different types of GPU instances, the operations further comprising:
determining metrics associated with GPU availability for each of the one or more different types of GPU instances in each geographic region.

15. The non-transitory computer-readable medium of claim 11, wherein the visualization includes a map showing the plurality of geographical regions color-coded representing different levels of GPU availability based on the metrics.

16. The non-transitory computer-readable medium of claim 15, the operations further comprising:
receiving a user selection of a region on the map; and
displaying the metrics related to GPU availability of the selected region.

17. The non-transitory computer-readable medium of claim 11, the operations further comprising:
predicting metrics associated with future GPU availability for each geographic region using a machine learning model trained on historical data related to GPU instances in the plurality of geographic regions, wherein the recommendation is further based on the predicted metrics associated with future GPU availability.

18. The non-transitory computer-readable medium of claim 11, wherein the metrics associated with GPU availability in the plurality of geographic regions include stability of spot GPU instances, and the recommendation for GPU allocation is further based on stability of spot GPU instances in each geographic region.

19. A system for visualizing stability of GPU instances in a cloud computing environment, the system comprising:
memory with instructions encoded thereon; and
one or more processors that, when executing the instructions, are caused to perform operations comprising:
obtaining current data related to GPU instances across a plurality of geographic regions of a plurality of cloud service providers;
determining, based on the obtained current data, metrics associated with GPU availability for each geographic region;
generating a visualization of GPU availability across the plurality of geographic regions, wherein each region is dynamically assigned a visual indicator based on its corresponding metrics, the visual indicator distinguishing different levels of metrics associated with GPU availability;
in response to detecting changes in metrics associated with GPU availability, updating the visualization of GPU availability based on changed metrics associated with GPU availability;
outputting for display a recommended GPU allocation based on the metrics associated with GPU availability across the plurality of geographic regions, the recommended GPU allocation including at least one recommended geographic region of at least one cloud service provider for GPU allocation;
displaying, via a graphical user interface, the visualization of GPU availability across the plurality of geographic regions and the GPU allocation recommendation.

20. The system of claim 19, wherein the metrics associated with GPU availability include availability ratios, which is a fraction of available GPU instances relative to a total number of GPU instances offered in a geographic region by a cloud service provider.
